(19) United States
(12) Patent Application Publication
(10) Pub. No.: US 2023/0192391 A1
(43) Pub. Date: Jun. 22, 2023

(54) PORTION CAPSULE AND METHOD FOR PRODUCING A PORTION CAPSULE

(71) Applicant: Tchibo GmbH, Hamburg (DE)

(72) Inventor: Jens Bröckel, Hamburg (DE)

(21) Appl. No.: 17/923,385

(22) PCT Filed: May 6, 2021
(86) PCT No.: PCT/EP2021/062070

§ 371 Date: Nov. 4, 2022

(30) Foreign Application Priority Data
May 8, 2020 (EP) 20173768.1

(51) Int. Cl. B65D 85/804; C08L 1/02

(52) U.S. Cl. CPC B65D 85/8046; B65D 85/8061; B65D 85/8064; C08L 1/02

(57) ABSTRACT

A portion capsule having a base element for receiving an extraction product, and a method for producing the portion capsule. The portion capsule has a bottom region and a circumferential side wall, wherein the bottom region and the circumferential side wall form an interior space. At least the circumferential side wall includes a cellulose-based sheet and is formed by a full winding of the cellulose-based sheet about a base element axis.

### BACKGROUND OF THE INVENTION

### Field of the Invention

The invention lies within the field of devices and methods for preparing beverages by means of a liquid introduced into a beverage capsule, a soluble food substance being present in the beverage capsule, from which a beverage or beverage component can be prepared by injecting water. The invention particularly lies within the field of preparing coffee by using a coffee capsule. The invention particularly relates to a portion capsule and a method for producing the portion capsule.

### Description of Related Art

Among the systems for preparing beverages, so-called coffee capsule systems (there are also variants for preparing tea) are known for which, in general, hot water is introduced into a capsule, typically under pressure, in order to prepare a coffee or tea beverage by extraction. The capsule is often pierced on one side (injection side) thereof for introducing the hot water. For discharging the brewed beverage on the other side of the capsule (the extraction side), in general, various possibilities are known. For one, there are systems in which piercing by means of corresponding perforation mandrels is provided on the extraction side as well. For another, systems are known in which a boundary of the capsule on the extraction side is pierced or torn under the interior pressure during the brewing process, for which a means external to the capsule (present in the brewing chamber of the corresponding coffee machine) or a means internal to the capsule can be present. Finally, there are also capsules already having been opened, for which no capsule wall/membrane needs to be pierced or torn in order to discharge the beverage.

The most common are capsules made of materials including neither biodegradable nor renewable raw materials. The capsules are made of aluminum or plastic, for example polypropylene (PP), in a high proportion, for example. Such capsules can have advantageous properties both for storing (e.g., impermeability, particularly impermeability to air/oxygen) and for the application (e.g., thermal dimensional stability, piercing behavior, etc.). A great disadvantage of such capsules is the waste occurring after use and the required high effort for recycling the materials used in the capsules. The latter includes collecting the capsules, typically used in the private sphere, transporting the same to recycling facilities, and the recycling process itself. In other words, even for recycling, significant resources (time, energy, and transport costs) must be expended and can in turn impact the environment (e.g., CO₂ emissions for transporting and for obtaining the energy required for recycling). The extraction product present in the capsule also typically is lost during recycling.

The use of less resource-intensive materials for portion capsules is per se known. The use of bio-plastics has particularly been discussed. Plastics produced from a renewable resource are referred to as such (so-called bio-based plastics). Bio-plastics are also plastics able to be biologically degraded (so-called biodegradable plastics). The plastics proposed for producing portion capsules are biodegradable and partially include a portion of bio-based plastics.

For example, WO 2011/015973 A1 discloses a capsule made entirely of biodegradable material, wherein the implementation of the membrane closing off the capsule is the primary focus of the teaching of WO 2011/015973 A1 and the material used is not addressed.

DE 202016104950 U1 discloses a hermetically closeable portion package or a hermetically closeable portion bag having a biodegradable capsule or a biodegradable pad, wherein the portion package or the portion bag is made entirely of biodegradable material. Bio-plastic such as polylactide (PLA) or Mater-Bi® are referred to as examples of the material used.

WO 2017/186743 A1 discloses the use of a bio-material for coffee and tea capsules, among other applications, wherein the bio-material is a biodegradable plastic and includes sunflower seed shells or sunflower seed hulls.

One disadvantage of the use of bio-plastics is that both producing and further processing the materials into portion capsules can be difficult and expensive.

The use of cellulose-based materials has been proposed as an alternative to bio-plastics.

WO 2017/017704 A1 shows a biodegradable capsule made of a wood material having reinforcing elements in order to be able to resist the pressure prevailing in the capsule during the brewing process.

WO 2017/072808 A1 discloses a capsule having a receptacle body made of a compostable and/or biodegradable material and a cover made partially of a fiber material, for example paper.

WO 2019/002420 A1 discloses a capsule made of 100% biodegradable and/or compostable material. The capsule is made of a wood-like material and no non-organic materials are used.

US 2014/0335236 A1 discloses a capsule made substantially of fiber material, particularly obtained from bamboo, bagasse, and other plants growing in excess and more rapidly than trees.

The use of cellulose-based material for portion capsules has various disadvantages. The design of the capsule is difficult and therefore correspondingly expensive, as is evident from WO 2017/017704 A1, for example, but also from WO 2017/072808 A1 and WO 2019/002420 A1. The shelf life of the unused portion capsules is also reduced and the requirements for storage are typically increased. Furthermore, degradation of taste, particularly a loss of intensity of the taste, is often associated with portion capsules based on cellulose. This is unsatisfactory for portion capsules for preparing food products unable to be subsequently refined, for example refreshed or seasoned, after being produced from the portion capsule. Coffee portion capsules are an example of portion capsules for which degradation of flavor is disastrous.

### SUMMARY OF THE INVENTION

One object of the present invention is to reduce one or more of the above disadvantage for portion capsules according to the prior art. A particular object of the invention is to reduce one or more of the above disadvantages for portion capsules including a cellulose-based material as a substantial component.

A particular object of the invention is to provide a portion capsule including a cellulose-based material as a substantial component and being easier to produce, less expensive to produce, improved with respect to shelf life, and/or improved with respect to flavor degradation, in comparison with portion capsules of the same type.

When reference is made below to a biodegradable plastic, typically a biodegradability according to EN 13432 (as of the end of 2019) or ASTM 6400 (as of the end of 2019) is meant.

A portion capsule according to the invention includes a base element having a bottom region and a circumferential side wall, wherein the bottom region and the circumferential side wall form an interior space. At least the circumferential side wall includes a cellulose-based sheet. The circumferential side wall is formed by a full winding of the cellulose-based sheet about a base element axis.

That is, the fundamental shape of the portion capsule is produced by simply forming the cellulose-based sheet into a shape closed about an axis, or the fundamental shape of the portion capsule is defined by the correspondingly formed cellulose-based sheet. The cellulose-based sheet is thereby not subjected to any further influences other than the forces directly required for forming. The portion capsule and the method for the production thereof thereby differs from the portion capsules and production methods typically used, for example based on thermal forming, injection molding, or deep drawing of suitable materials.

The circumferential side wall can include a fixing region in which at least the winding is permanently fixed. The fixing can be such that a flow of solid, liquid, or gaseous materials through the fixing region is not possible. The fixing can be implemented by means of adhesive or ultrasonic welding, for example, particularly as described in detail below.

The impermeability of the fixing region to liquids and/or gaseous materials can be increased in that a sealing layer or a barrier layer, or a sealing layer and a barrier layer covers the inner side and/or the outer side of the fixing region in one of the embodiments described below.

In addition or alternatively, the impermeability can be increased by applying an adhesive strip in a region completely or at least mostly including the fixing region.

As described below, further elements of the portion capsule can be produced by simply forming one or more cellulose-based sheets.

As described below, even the entire portion capsule can be produced by simply forming one or more cellulose-based sheets.

The circumferential side wall can include the cellulose-based sheet, in that said wall is substantially made of the cellulose-based sheet. In the present context, “substantially” means that the circumferential side wall can include further components, but that the shape and stability of the circumferential side wall are defined by the cellulose-based sheet. The circumferential side wall can, for example, include further components only in the form of layers (for example, the sealing and barrier layers described below), inscriptions, codes, etc.

In one embodiment, the circumferential side wall includes the cellulose-based sheet such that the shape and mechanical stability of the circumferential side wall are defined by the cellulose-based sheet.

A cellulose-based sheet is understood to be a component extending in a planar manner, having a limited thickness, being deformable, and being made of a high proportion of cellulose.

The component (cellulose-based sheet) is particularly not deformable or only destructively deformable by a force running along the area defined by the planar extent of the component, and is deformable by a force including a component perpendicular to the area.

The planar extent is typically such that the circumferential side wall can be formed as a single piece. When the circumferential side wall is formed by a plurality of windings of the cellulose-based sheet, the planar extent can be such that the plurality of windings can be formed as a single piece. The planar extent can optionally be such that further elements of the portion capsule, particularly the bottom region and/or a capsule cover, can be formed by the cellulose-based sheet. Such embodiments are described in detail below.

The thickness of the cellulose-based sheet can particularly be less than 5, 4, 3, or 2 mm. The thickness can be greater than 0.1, 0.2, 0.3, 0.4, or 0.5 mm. Thicknesses of 0.2 mm or greater are particularly interesting. For example, the thickness can be between 0.2 and 3 mm, particularly between 0.5 and 2 mm.

The cellulose-based sheet can particularly be a paper, card, or cardboard. In other words, at least the circumferential side wall can be based on a sheet of paper, carton, or cardboard.

In one embodiment, the base element is a convolute can.

As a rule, the full winding is a winding about a straight base element axis.

The base element can be implemented in a cup shape. The interior space can extend from an opening in the direction of the bottom region, for example along the base element axis, being a cup axis in the present embodiment. The circumferential side wall can bound the interior region in radial directions (radial with respect to the cup axis).

In one embodiment, the circumferential side wall includes at least one planar region and at least one corner region. That is, the circumferential winding is not a “round” winding, but rather includes at least one planar region and at least one corner region. This can be achieved, for example, by using a winding core and/or by preprocessing the cellulose-based sheet.

The cellulose-based sheet can include at least one intended fold. The intended fold or folds can be disposed and configured so that an intended shape of the circumferential side wall, and thus of the portion capsule, results when folded along the intended fold(s).

The base element can be cup-like and can have a rectangular, particularly square, basic shape.

In other words, the base element can include the base element axis (cup axis) along which the opening extends. The base element can then have a rectangular, particularly square, basic shape in a section perpendicular to the base element axis (cup axis).

The base element can have the shape of a cuboid, particularly of a cube, wherein one side of the cuboid or cube is open.

A capsule cover, particularly a capsule cover as described below, can have a shape for sealing off the opening of the cuboid or cube. That is, the capsule cover can have substantially the shape of a side of the cuboid or cube formed by the base element (for example, except for elements necessary for attaching and/or the functionality of the capsule cover).

In one embodiment, the cellulose-based sheet includes a sealing layer or a barrier layer, or a sealing layer and a barrier layer.

The sealing layer, the barrier layer, or the sealing layer and the barrier layer can particularly be disposed on the cellulose-based sheet. That is, the cellulose-based sheet can form a type of substrate to which the sealing layer, the barrier layer, or the sealing layer and the barrier layer are applied.

The sealing layer can be particularly configured for reducing the liquid permeability, particularly water permeability, through the cellulose-based sheet.

The sealing layer is consequently typically a liquid sealing layer.

The sealing layer can be configured for closing off pores of the cellulose-based sheet.

The sealing layer can preferably be made of a biodegradable material. The sealing layer can particularly be made of a bio-plastic, particularly a biodegradable plastic, such as polylactide (PLA). Other biodegradable plastics, such as polybutylene adipate terephthalate (PBAT) or a mixture of polybutylene adipate terephthalate (PBAT) and polylactide (PLA), are also conceivable. Furthermore, compounds including a bio-plastic and polyvinyl alcohol (PVOH), such as PLA/PVOH compounds having 20%-30% PVOH mass proportion, for example, have been found to be very interesting.

The barrier layer can be configured particularly for reducing the permeability of gaseous materials, particularly oxygen but also water vapor, through the cellulose-based sheet. The presence of oxygen in the portion capsule accelerates the loss of flavor and is therefore a main driver of flavor degradation.

The barrier layer is consequently typically a gas transmission barrier layer.

The barrier layer can be an oxygen barrier layer.

The barrier layer can be particularly an SiOₓ layer, an AlOₓ layer, or a combination of SiOₓ layer and AlOₓ coating, for example a sequence of at least one SiOₓ and one AlOₓ layer.

SiOₓ and AlOₓ have the advantage that said materials can be applied after winding the cellulose-based sheet or even after forming the base element, for example by means of vacuum coating. Seamless coating is thereby possible. Particularly for applying by means of vacuum coating, the deposition of the barrier layer on a flange, present in any case, for welding to the capsule cover can be prevented, for example by covering (masking) the flange during coating.

In one embodiment, the sealing layer, the barrier layer, or the sealing layer and the barrier layer are applied to the cellulose-based sheet facing toward the interior space.

In other words, the cellulose-based sheet from which the circumferential side wall is formed can include the sealing layer or the barrier layer, or the sealing layer and the barrier layer so that the sealing layer or the barrier layer, or the sealing layer and the barrier layer are disposed facing toward the interior space.

The sealing layer, the barrier layer, or the sealing layer and the barrier layer can continuously cover the entire region of the cellulose-based sheet forming all or part of the interior space.

For example, the sealing layer or the barrier layer, or the sealing layer and the barrier layer can continuously cover the entire region of the cellulose-based sheet facing toward the interior space. In other words, the region of the interior space can be coated by the sealing layer or the barrier layer, or the sealing layer and the barrier layer.

“Continuously cover” means, in the present context, that no openings or perforations are present in the sealing layer or the barrier layer, or the sealing layer and the barrier layer.

In one embodiment, the cellulose-based sheet includes a sealing layer facing toward the interior space and covered by a barrier layer. The sealing layer and the barrier layer can be implemented in one of the ways explained above. For example, the sealing layer can be made of PLA and the barrier layer can be made of SiOₓ. The barrier layer can particularly be an oxygen barrier layer. The sealing layer and the barrier layer can continuously cover the cellulose-based sheet at least toward the interior space.

Regardless of the concrete embodiment, a bonding layer can be present between the cellulose-based sheet and one layer and/or between two adjacent layers.

In one embodiment, a sealing layer, a barrier layer, or the sealing layer and the barrier layer are applied to the cellulose-based sheet facing outward.

The sealing layer, barrier layer, or sealing layer and barrier layer applied facing outward can be present in addition to the sealing layer, barrier layer, or sealing layer and barrier layer applied to the cellulose-based sheet facing toward the interior space.

If the layer or layers are additional, then the arrangement can lead to improved sealing of the interior space outwardly. Furthermore, welding, such as welding to a capsule cover or welding of the winding, can thereby be facilitated.

A sealing layer, barrier layer, or sealing layer and barrier layer applied facing outward can be implemented in a manner as was explained in conjunction with the sealing layer, barrier layer, or sealing layer and barrier layer applied facing toward the interior space.

In some embodiments, at least one further part of the portion capsule in addition to the circumferential side wall can include the cellulose-based sheet or be substantially made thereof. The region of the cellulose-based sheet forming the additional part can include a sealing layer and/or a barrier layer as described above.

“Substantially” means, in the present context, that the at least one further part can include further components, but that the shape and stability of the at least one further part are defined by the cellulose-based sheet. For example, further components can be provided only in the form of layers (for example, as described above), inscriptions, codes, etc.

The bottom region or the capsule cover can particularly be a further part. It is also conceivable that both the bottom region and the capsule cover are further regions in the above sense.

In one embodiment, the bottom region is formed from the cellulose-based sheet, optionally preferably including the sealing layer and/or the barrier layer as described above.

In one embodiment, alternatively or in addition to the bottom region, the capsule cover is formed from the cellulose-based sheet, optionally preferably including the sealing layer and/or the barrier layer as described above.

For example, the portion capsule can include the cellulose-based sheet optionally including the sealing layer and/or the barrier layer, as follows:
The cellulose-based sheet is formed, for example, cut, so that the portion capsule includes the circumferential side wall by means of a full winding and the bottom region and/or the capsule cover in the form of a fold region. In other words, the bottom region and/or the capsule cover is formed by a folded region of the cellulose-based sheet.
The fold region for the bottom region and/or the fold region for the capsule cover can be implemented so that the corresponding fold region completely closes off the interior space after folding in the area in which the corresponding fold region is disposed.
The fold region for the bottom region and/or the fold region for the capsule cover can be implemented so that the interior space in the area of the fold region is sealed after folding by applying a force pressing from the interior space onto the fold region. In other words, the fold region for the bottom region and/or the fold region for the capsule cover can be implemented so that a force acting on the fold region out of the interior region presses elements of the fold region against each other after folding and thus seals off any openings present.
In addition or alternatively, a fixing means, particularly a biodegradable fixing means, for example a biodegradable adhesive, can be applied to the fold region for the bottom region and/or to the fold region for the capsule cover.
The region of the cellulose-based sheet forming the bottom region and/or the region of the cellulose-based sheet forming the capsule cover includes a sealing layer or a barrier layer, or a sealing layer and a barrier layer of the types described above. The sealing layer or the barrier layer, or the sealing layer and the barrier layer can particularly be disposed facing toward the interior space and can cover the region of the cellulose-based sheet so that the entire region facing toward the interior space is covered.
The sealing layer or the barrier layer, or the sealing layer and the barrier layer in the region can be in addition to a sealing layer or a barrier layer, or a sealing layer and a barrier layer in a region forming the circumferential side wall.
The region of the cellulose-based sheet forming the circumferential side wall and the bottom region or forming the circumferential side wall and the capsule cover or forming the circumferential side wall, the bottom region, and the capsule cover can include the sealing layer or the barrier layer or preferably the sealing layer and the barrier layer, so that the formed interior space is continuously coated with the sealing layer or the barrier layer or preferably with the sealing layer and the barrier layer. That is, the sealing layer or the barrier layer or preferably the sealing layer and the barrier layer continuously covers the entire resulting region of the capsule cover facing toward the interior space in each of the three indicated embodiments of the cellulose-based sheet.
The region of the cellulose-based sheet forming the circumferential side wall, the bottom region, and the capsule cover can particularly include the sealing layer or the barrier layer or preferably the sealing layer and the barrier layer, so that the entire interior space, closed in the present case, is entirely and continuously coated with the sealing layer or the barrier layer or preferably with the sealing layer and the barrier layer.

If the bottom region and/or the capsule cover is formed from the cellulose-based sheet optionally including the sealing layer and/or the barrier layer as described above, then the portion capsule can include one or more attaching areas for guaranteeing the shape stability of the portion capsule and for ensuring that a closed interior space is formed.

If, for example, the bottom region is formed from the cellulose-based sheet by folding, then the bottom region can include an attaching area by means of which the fold is permanent and dimensionally stable. The attaching area thereby advantageously extends such that any leaks present after folding are closed.

For example, the attaching area can extend along a line, wherein the line can be curved.

The attaching area can include beading, adhering, or welding, particularly ultrasonic welding as described in the context of attaching the capsule cover and/or fixing the winding.

If the capsule cover is formed by folding the cellulose-based sheet, then the same can apply analogously.

If the bottom region and/or the capsule cover is formed from the cellulose-based sheet optionally including the sealing layer and/or the barrier layer as described above, then the portion capsule can include at least one sealing area in addition to an attaching area. A potential leak is closed in the sealing area.

The sealing area can include an originally liquid or flowable, cured material applied locally, particularly applied after folding.

The sealing area and/or the attaching area can include a material of the cellulose-based sheet temporarily brought into a flowable state.

The material can be the material of the sealing layer, for example. It is also conceivable, however, that the cellulose-based sheet includes material in addition to any sealing layer present and able to be brought into a flowable state, at least at a site of a potential leak and/or at a suitable attaching point. The cellulose-based sheet can particularly include the material at an edge of the unfolded cellulose-based sheet or at the edge of the unwound cellulose-based sheet or at the edge of the unfolded and unwound cellulose-based sheet. Alternatively, the sealing area and/or the attaching area can include material applied after folding and/or winding. The material can particularly be the material able to be brought into a flowable state.

Alternatively to a base cover formed from the cellulose-based sheet and also forming the circumferential side wall, the portion capsule can include a cellulose-based bottom region sheet and the bottom region can be formed from the cellulose-based bottom region sheet.

In other words, the bottom region can be formed of a cellulose-based sheet (the cellulose-based bottom region sheet) originally separate from the cellulose-based sheet forming the circumferential side wall.

The cellulose-based bottom region sheet can be structurally identical to the cellulose-based sheet forming the circumferential side wall.

Alternatively, the cellulose-based bottom region sheet can be structurally different from the cellulose-based sheet forming the circumferential side wall. For example, the cellulose-based bottom region sheet can differ in piercing behavior and/or in sealing behavior with respect to an injector or extractor penetrating the cellulose-based bottom region sheet. The cellulose-based bottom region sheet can, for example, differ in thickness and/or composition from the cellulose-based sheet forming the circumferential side wall.

The cellulose-based bottom region sheet can include a sealing layer or a barrier layer, or a sealing layer and a barrier layer in any of the ways described above.

The sealing layer or the barrier layer or preferably the sealing layer and the barrier layer can particularly continuously cover the entire region of the cellulose-based bottom region sheet co-forming the interior space, for example on the side facing toward the interior space.

In addition or alternatively, the cellulose-based bottom region sheet can include a sealing layer or a barrier layer, or a sealing layer and a barrier layer in any of the ways described above and disposed facing outward.

In one embodiment, the bottom region is beaded to the circumferential side wall.

In other words, the cellulose-based bottom region sheet is beaded to the cellulose-based sheet forming the circumferential side wall.

The cellulose-based bottom region sheet is particularly circumferentially beaded to the cellulose-based sheet forming the circumferential side wall.

Other types of attaching, for example indicated in conjunction with capsule cover, are also conceivable.

The cellulose-based sheets beaded or otherwise attached to each other can include a sealing layer or a barrier layer, or a sealing layer and a barrier layer in any of the ways described above. At least one of the layers can particularly be disposed so that the entire interior space formed by the two sheets and/or the entire outer surface formed by the two sheets are continuously coated by the sealing layer or the barrier layer, or the sealing layer and the barrier layer.

Alternatively to a capsule cover formed from the cellulose-based sheet and also forming the circumferential side wall, the portion capsule can include a cellulose-based capsule cover sheet and the capsule cover can be formed from the cellulose-based bottom region sheet.

In other words, the capsule cover can be formed from a cellulose-based sheet (the cellulose-based capsule cover sheet) originally separate from the cellulose-based sheet forming the circumferential side wall.

The cellulose-based capsule cover sheet can be structurally identical to the cellulose-based sheet forming the circumferential side wall.

Alternatively, the cellulose-based capsule cover sheet can be structurally different from the cellulose-based sheet forming the circumferential side wall. For example, the cellulose-based capsule cover sheet can differ in piercing behavior and/or in sealing behavior with respect to an injector or extractor penetrating the cellulose-based capsule cover sheet. The cellulose-based capsule cover sheet can, for example, differ in thickness and/or composition from the cellulose-based sheet forming the circumferential side wall.

The cellulose-based capsule cover sheet can be structurally identical to the cellulose-based bottom region sheet. As a rule, however, the cellulose-based capsule cover sheet differs from the cellulose-based bottom region sheet, for example in one of the properties indicated above. The cellulose-based capsule cover sheet can further differ from the cellulose-based bottom region sheet in an additional element supported by the same. Examples of such additional elements are described below. The cellulose-based capsule cover sheet can further differ from the cellulose-based bottom region sheet in elements relating to attaching the cellulose-based capsule cover sheet to the cellulose-based sheet forming the circumferential side wall.

In one embodiment, the capsule cover is beaded to the circumferential side wall or is configured for being beaded to the circumferential side wall.

In other words, the cellulose-based capsule cover sheet is beaded to the cellulose-based sheet forming the circumferential side wall, or the cellulose-based capsule cover sheet is configured for being beaded to the cellulose-based sheet forming the circumferential side wall.

The cellulose-based capsule cover sheet is particularly circumferentially beaded to the cellulose-based sheet forming the circumferential side wall, or the sheet is configured for being circumferentially beaded to the cellulose-based sheet forming the circumferential side wall.

Alternatively—and often preferably—the capsule cover is attached to or can be attached to the circumferential side wall in a different manner. For example, the capsule cover or the cellulose-based capsule cover sheet can be configured for being welded to the circumferential side wall, for example by means of ultrasonic welding.

The cellulose-based capsule cover sheet can include a plastic, particularly a biodegradable plastic, for welding to the material of the circumferential side wall.

The plastic can be the plastic used for the sealing.

The welding can be based on the plastic of the capsule cover disposed for welding penetrating into structures of the cellulose-based sheet forming the circumferential side wall.

Alternatively, the capsule cover or the cellulose-based capsule cover sheet can be configured for being glued to the circumferential side wall.

The cellulose-based capsule cover sheet can include a sealing layer or a barrier layer, or a sealing layer and a barrier layer in any of the ways described above.

The sealing layer or the barrier layer or preferably the sealing layer and the barrier layer can particularly continuously cover the entire region of the cellulose-based capsule cover sheet co-forming the interior space, for example on the side facing toward the interior space.

In addition or alternatively, the cellulose-based capsule cover sheet can include a sealing layer or a barrier layer, or a sealing layer and a barrier layer in any of the ways described above and disposed facing outward.

The cellulose-based capsule cover sheet and the cellulose-based sheet can include a sealing layer or a barrier layer, or a sealing layer and a barrier layer in any of the previously described ways, so that after attaching the cellulose-based capsule cover sheet to the cellulose-based sheet, the entire interior space formed by the two sheets and/or the entire outer surface formed by the two sheets is continuously coated by the sealing layer or the barrier layer, or the sealing layer and the barrier layer.

In one embodiment, the portion capsule includes the cellulose-based sheet forming the circumferential side wall, the cellulose-based bottom region sheet, and the cellulose-based capsule cover sheet, wherein the sheets each include the sealing layer or the barrier layer or preferably the sealing layer and the barrier layer, so that the entire interior space of the portion capsule is continuously coated with the sealing layer or the barrier layer or preferably with the sealing layer and the barrier layer.

In the present embodiment, the interior space is typically a closed interior space.

In addition or alternatively, the sheets can include the sealing layer or the barrier layer or preferably the sealing layer and the barrier layer, so that the entire outer surface formed by the sheets is continuously coated with the sealing layer or the barrier layer or preferably with the sealing layer and the barrier layer.

Regardless of the concrete implementation of the bottom region and the capsule cover, the bottom region and/or the capsule cover and the cellulose-based sheet forming the same can be the carrier of an additional element disposed inside the interior space.

The additional element can be an element, for example, configured for optimizing the flow through the capsule of a liquid introduced via the bottom region or the capsule cover.

The additional element can be a filter, for example, particularly a filter configured for filtering a beverage discharged via the bottom region or the capsule cover of the portion capsule.

Regardless of the concrete implementation of the capsule cover, the capsule cover in some embodiments seals off the interior space formed by the bottom region and the circumferential side wall, or is configured for sealing off the interior space formed by the bottom region and the circumferential side wall.

As mentioned, the sealing layer or the barrier layer, or the sealing layer and the barrier layer can continuously cover the entire region of the capsule cover facing toward the interior space when the capsule cover is attached to the circumferential side wall.

The capsule cover can vary from a simple film or plate and can be implemented as a three-dimensional object, and can form an outward dome, for example.

In embodiments, the capsule cover is characterized in that the cover forms an outward dome radially internally from a circumferential cover flange forming an attaching part during the attaching to the circumferential side wall, wherein the dimensions of the circumferential cover flange are matched to a flange of the circumferential side wall (or the base element). The capsule cover according to the present embodiment thus is differentiated from a flat cover element, for example a film-like or plate-like cover element. The cover is a three-dimensionally formed body.

The shape of the capsule cover in such embodiments can include, from outside to inside, the cover flange, a curved transition region, and a central flat region forming the actual top cover surface. Such a flat region is offset outwardly from the plane of the cover flange due to the transition region bringing about the dome. The transition region can be curved in an S-shape, for example, or can be constantly curved from an outer part, at an angle to the flange plane, to a center, flat region. The dimensions thereof are thereby selected, for example, so that the center, flat region dominates optically, in that the region is the same size as or only slightly (e.g. maximum of 10%) smaller than the area of the bottom region. For an embodiment of the portion capsule as an overall cuboid or cube shape, it can be provided particularly that said flat region occupies more than 60% of the diameter and accordingly at least 40% of the area.

The cover flange generally forms a circumferential area facing the capsule cover side and extending from an outer edge of the flange to a start of the dome. In some embodiments, it can be provided that the start of the dome is offset inwardly in comparison with the portion of the side wall at which the flange contacts the circumferential side wall. Such an offset can be, for example, a minimum of 0.2 mm.

The portion capsule resulting from the elements “circumferential side wall”, “bottom region” and “capsule cover” described above can particularly be implemented so that the extraction product is completely enclosed, for example without an opening covered by a film or the like. The capsule can particularly be hermetically sealed and oxygen-tight, for example in that the capsule includes at least one said diffusion barrier, particularly a sealing layer and/or a barrier layer. The capsule can particularly have a rectangular cross section in the shape described in the present text.

One consideration of the invention relates to a method for producing a portion capsule, particularly a portion capsule according to any one of the previously described embodiments, including a base element having a bottom region and a circumferential side wall.

The method according to the invention includes the following steps:
Providing a cellulose-based sheet.
The cellulose-based sheet is particularly the cellulose-based sheet described in conjunction with the portion capsule according to any one of the described embodiments.
Forming the circumferential side wall from the cellulose-based sheet, wherein forming the circumferential side wall includes a full winding of the cellulose-based sheet about a base element axis.
After forming, the circumferential side wall can particularly be formed as described in conjunction with the portion capsule.
Forming takes place particularly as disclosed in conjunction with the portion capsule.

The method can include a step in which the bottom region is provided. The bottom region provided can particularly be a bottom region as disclosed in conjunction with the portion capsule.

Providing the bottom region can include at least one of the following steps, for example:
Providing a cellulose-based bottom region sheet.
The cellulose-based bottom region sheet can particularly be the cellulose-based bottom region sheet described in conjunction with the portion capsule according to any one of the described embodiments.
Forming the bottom region from the cellulose-based bottom region sheet.
The formed bottom region sheet can include a region for attaching to the circumferential side wall, for example by means of beading, welding, or gluing.
Processing the cellulose-based sheet from which the circumferential side wall is formed so that the cellulose-based sheet includes a side wall part by means of which the full winding can be formed and a bottom region part from which the bottom region can be formed.
The cellulose-based sheet can be cut to shape accordingly, for example. The sheet can also be provided with intended folds.

The method can include a step in which the bottom region is implemented on the portion capsule.

For example, the bottom region can be implemented on the portion capsule by any one of the following steps:
Beading the bottom region, particularly a correspondingly formed cellulose-based bottom region sheet, to the circumferential side wall.
Forming the full winding and the bottom region by folding before, during, or after forming the circumferential side wall. The bottom region part of the cellulose-based sheet can particularly be folded over.

The method can include a step in which the capsule cover is provided. The capsule cover provided can particularly be a capsule cover as disclosed in conjunction with the portion capsule.

Providing the capsule cover can include at least one of the following steps, for example:
Providing a cellulose-based capsule cover sheet.
The cellulose-based capsule cover sheet is particularly the cellulose-based capsule cover sheet described in conjunction with the portion capsule according to any one of the described embodiments.
Forming the capsule cover from the cellulose-based capsule cover sheet.
The formed capsule cover sheet can include a region for attaching to the circumferential side wall, for example by means of beading, welding, or gluing, particularly as described in conjunction with the portion capsule.
Processing the cellulose-based sheet from which the circumferential side wall is formed so that the cellulose-based sheet includes a side wall part by means of which the full winding can be formed and a capsule cover part from which the capsule cover can be formed.
The cellulose-based sheet can be cut to shape accordingly, for example. The sheet can also be provided with intended folds.

The method can include a step in which the capsule cover is implemented on the portion capsule.

For example, the capsule cover can be implemented by any one of the following steps:
Attaching the capsule cover, particularly a correspondingly formed capsule cover sheet, to the circumferential side wall, for example as described in conjunction with the portion capsule (e.g., welding, gluing, beading).
Forming the full winding and the capsule cover by folding before, during, or after forming the circumferential side wall. The capsule cover part of the cellulose-based sheet can particularly be folded over.

In one embodiment, the method includes a step of applying a sealing layer or a barrier layer, or a sealing layer and a barrier layer to at least one of the following sheets: the cellulose-based sheet, the cellulose-based bottom region sheet, the cellulose-based capsule cover sheet.

The sealing layer and the barrier layer are particularly layers as described in conjunction with the portion capsule.

The sealing layer and/or the barrier layer can be applied by means of a method as described in conjunction with the portion capsule, for example by vacuum coating.

The sealing layer and/or barrier layer can be disposed on the cellulose-based sheet, the cellulose-based bottom region sheet, and/or the cellulose-based capsule cover sheet, as described in conjunction with the portion capsule.

The step of applying can also be prior to a step of forming. That is, the sealing layer and/or barrier layer can be applied to the flat cellulose-based sheet, the flat cellulose-based bottom region sheet, and/or the flat cellulose-based capsule cover sheet.

Alternatively, at least one first step of forming can be performed prior to the step of applying.

### BRIEF DESCRIPTION OF THE DRAWINGS

Embodiment examples of the invention are described below using figures. Shown are:

FIG. 1 a side view of an example of a portion capsule including a base element and a capsule cover;

FIG. 2 a detail view of the base element;

FIG. 3 a detail view of the capsule cover;

FIG. 4a-c a further example of a base element (FIG. 4a), and the cellulose-based sheet (FIG. 4b) and the cellulose-based bottom region sheet (FIG. 4c) from which said element is formed;

FIG. 5a-b an example of a cellulose-based sheet (FIG. 5a) and an example of a cellulose-based bottom region sheet (FIG. 5b) for a base element having a square basic shape;

FIG. 6 a method for producing a coffee portion capsule ready for consumption.

### DETAILED DESCRIPTION OF THE INVENTION

Identical reference numerals in the figures indicate identical or analogous elements.

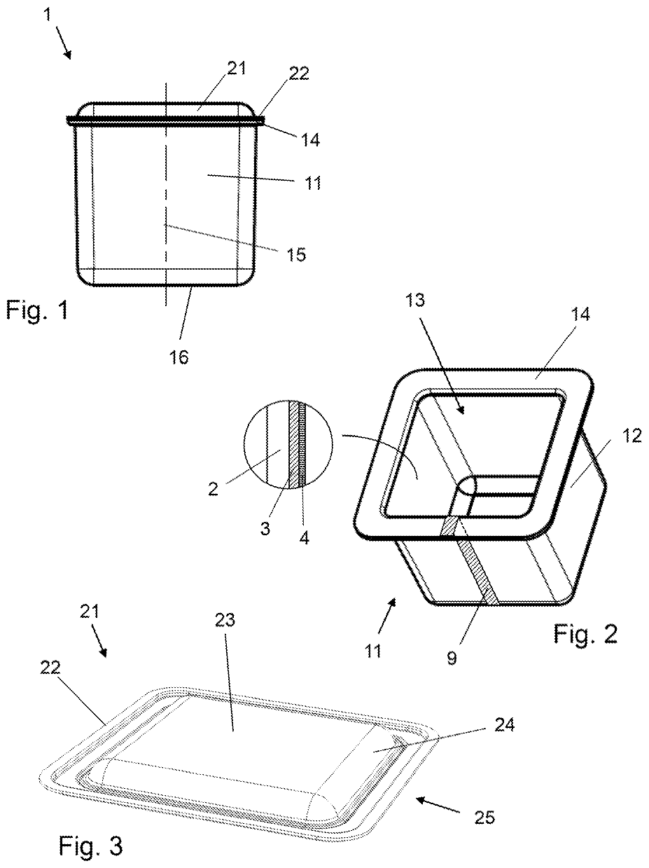

The example of a portion capsule 1 according to FIG. 1 includes a base element 11 having a base element axis 15. The base element 11 shown has the shape of a cup, wherein the base element axis 15 is a cup axis. The portion capsule 1 further includes a capsule cover 21 attached along a circumferential flange 14 of the base element (cup) 11, wherein the base element 11 and the capsule cover 21 together form an outer capsule wall and define a capsule interior space. The base element 11 shown forms a slightly domed bottom region (capsule base) 16 and a circumferential side wall 12, as is per se known. The flange 14 shown is implemented as a flange on the circumferential side wall 12.

In the embodiment shown, the base element 11 and capsule cover 21 are formed from a cellulose-based sheet, more precisely a paper sheet, wherein the base element 11 is formed from a first cellulose-based sheet 2 and wherein the capsule cover 21 is formed from a second cellulose-based sheet, the cellulose-based capsule cover sheet 25.

In the embodiment shown, the capsule cover 21 is attached to the base element 11 by means of ultrasonic welding or gluing. Alternatively, thermal welding is also conceivable, for example. Thermal welding can take place, for example, using an embossment supporting the welding process. The embossment can be disposed particularly on a surface to be welded of the welding partners, that is, of the capsule cover 21 and/or of the base element 11.

For the case of ultrasonic welding, at least the area of the flange 14 facing toward the capsule cover 21 or at least one area of a circumferential cover flange 22 facing toward the flange 14 includes a material for becoming flowable under ultrasound and pressure. The material is disposed and/or the areas are shaped so that, no later than during ultrasonic welding, the material disposed on one piece (flange 14 or cover flange 22) makes at least partial contact with the facing area of the other piece (cover flange 22 or flange 14). If, for example, only the flange 14 of the base element 11 includes the material, then the material makes contact with the area of the cover flange 22 facing the flange 14 of the base element 11 no later than during the ultrasonic welding of the capsule cover 21 to the base element 11.

For example, the material can be disposed on the surface of the flange and/or on the surface of the circumferential cover flange 22. The material can, however, also be covered by at least one further layer through which the material penetrates during the ultrasonic welding process, or through which at least a part of the facing surface of the counterpart (flange 14 if the cover flange 22 includes the covered material, cover flange 22 if the flange 14 includes the covered material) penetrates during the ultrasonic welding process. The part can be a circumferential protrusion, for example.

The material can particularly be the liquid sealing layer (sealing layer 3 for short) described below. The barrier layer described below, being a gas transmission barrier layer in the embodiments shown, more specifically an oxygen barrier layer 4, can be a layer covering the material in the above sense.

FIG. 2 shows a detail view of the base element 11. The base element 11 is cup-like and has a square basic shape. That is, the base element 11 substantially has the shape of a cube, one of the six sides of the cube being missing and forming an opening 13. Extraction product can be introduced into the interior space of the base element 11 and thus into the interior capsule space via said opening 13. Other basic shapes, such as a round basic shape (base element having substantially the shape of a cylinder open on one flat side), are conceivable.

In the embodiment shown, the circumferential edge 14 to which the capsule cover 21 can be attached, the rounded edges, and at most slightly domed sides primarily deviate from the shape of a cube. Depending on how the bottom region 16 is connected to the circumferential side wall 12, further deviation from the shape of a cube is possible. This is particularly the case if the bottom region 16 is beaded to the circumferential side wall 12 or if the bottom region is applied to the circumferential side wall 12 analogously to the capsule cover. If, however for example, the bottom region 16 is formed by a simple folding over of the cellulose-based sheet 2 in comparison with beading, including an attaching area in any case and optionally a sealing area (e.g., in the area of the corners), then the additional deviation from the shape of a cube may be relatively small.

The circumferential side wall 12 of the base element 11 shown is implemented as a full winding of the cellulose-based sheet 2 about the base element axis 15. That is, the cellulose-based sheet 2 is disposed about the base element axis 15 so that a starting region and an end region of the cellulose-based sheet 2 overlap in a fixing region 9 of the winding. The starting region is permanently connected to the end region, for example in that the regions are glued to each other or connected by means of ultrasonic welding. The permanent winding thus implemented forms the circumferential side wall 12 of the base element 11.

In the fixing region 9, both the starting region and the end region include an area for bringing into contact with each other during fixing. For the case of fixing by means of ultrasonic welding, at least one of the areas includes a material for becoming flowable under ultrasound and pressure. The material is disposed and/or the areas are shaped so that, no later than during ultrasonic welding, the material disposed on one piece (starting region or end region) makes at least partial contact with the facing area of the other piece (end region or starting region). If, for example, only the end region includes the material, then the region makes contact with the area of the starting region facing toward the end region no later than during fixing by means of ultrasonic welding.

The material can be disposed, for example, on the surface of the starting region and/or on the surface of the end region. The material can, however, also be covered by at least one further layer through which the material penetrates during the ultrasonic welding process, or through which at least a part of the facing surface of the counterpart (starting region if the end region includes the covered material, end region if the starting region includes the covered material) penetrates during the ultrasonic welding process. The part can be a protrusion, for example.

The cellulose-based sheet 2, from which the circumferential side wall 12 is formed, includes a sealing layer 3 and an oxygen barrier layer 4 in the embodiment shown.

In the embodiment shown, the sealing layer 3 is a PLA layer and the oxygen barrier layer 4 is an SiOₓ layer.

The sealing layer 3 is—other than a potentially present bonding layer—directly disposed on the cellulose-based sheet 2, while the oxygen barrier layer 4 is—other than a potentially present bonding layer—directly disposed on the sealing layer 3.

The sealing layer 3 and oxygen barrier layer 4 are disposed, or the cellulose-based sheet 2 carrying the layers is wound about the base element axis 11, so that the sealing layer 3 and the oxygen barrier layer 4 are disposed toward the interior space of the base element 11 on the cellulose-based sheet 2.

The sealing layer 3 and oxygen barrier layer 4 are disposed so that the entire interior space bounded by the base element 11 is continuously coated by both of said layers.

Such an implementation of the cellulose-based sheet 2 and the layers present thereon can lead to only the end region including the material for becoming flowable under ultrasound and pressure, such that the material can make contact with the starting region no later than during the ultrasonic welding.

This is particularly the case when—as in the embodiment according to FIG. 2—the material for becoming flowable during the ultrasonic welding process is the material of the sealing layer 3. The oxygen barrier layer 4 is then a layer penetrated by the liquefied material of the sealing layer 3 and/or penetrated by the material of the counterpart (the starting region) during the ultrasonic welding process.

FIG. 3 shows a detail view of the capsule cover 21. In the embodiment shown, the capsule cover 21 is formed from the cellulose-based capsule cover sheet 25 and is separate from the cellulose-based sheet 2 from which the circumferential side wall 12 is formed prior to attaching the capsule cover 21 to the base element 11.

The capsule cover 21 shown includes the layer sequence of sealing layer 3 and oxygen barrier layer 4 shown in conjunction with the base element 11, wherein the layers are disposed on the cellulose-based capsule cover sheet 25 so that the closed interior space of the portion capsule 1 formed after attaching the capsule cover 21 to the base element 11 is continuously coated by said layers.

The capsule cover 21 includes a circumferential flange 22 matched to the flange 14 of the base element 11, so that the capsule cover 21 can seal off the base element 11 in a fluid-tight manner when appropriately attached.

The capsule cover 21 shown in FIG. 3 is not implemented as a simple sheet representing a two-dimensional object, other than the thickness of the sheet. Such two-dimensional capsule covers are known from the prior art in the form of films or plates.

Instead, the capsule cover 21 shown in FIG. 3 includes an outward dome 23. The dome 23 forms a flat region in the center thereof. The flat region is offset outward relative to a plane defined by the circumferential cover flange 22. The dome 23 and cover flange 22 are connected to each other by means of a transition region 24.

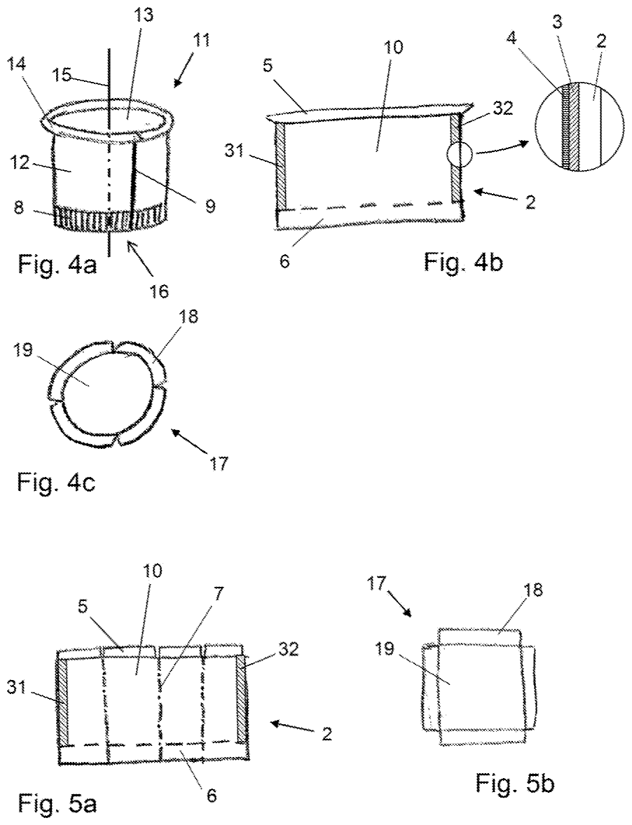

FIG. 4 shows an example of a base element 11 having the shape of a cup having a round basic shape. That is, the base element 11 substantially has the shape of a cylinder, wherein one flat side of the cylinder is open. The open, flat side defines the opening 13 for introducing the extraction product into the interior space of the base element 11 and thus into the interior capsule space. The cup is oriented along the base element axis 15, to be considered as the cup axis in the embodiment shown.

The base element 11 shown further includes a flange 14 circumferentially enclosing the opening 13. The flange 14 can be implemented in any one of the ways described above, except for the shape thereof (circular instead of square basic shape).

A capsule cover 21 can be implemented in any one of the ways described above, except for being matched to the shape of the flange 14 and the opening 13. The capsule cover 21 can be attached or attachable to the base element 11 in any one of the ways described above.

The circumferential side wall 12 of the base element 11 is formed by a cellulose-based sheet 2 forming a full winding about the base element axis 15. The cellulose-based sheet 2, the winding, and the fixing thereof in a fixing region 9 can—except for differences caused by the different shape of the base element 11—be implemented in one of the ways described above.

The bottom region 16 of the base element 11 is formed by a cellulose-based bottom region sheet 17 separate from the cellulose-based sheet 2 prior to forming the base element 11.

In the embodiment shown, the base element 11 includes a bead 8 on the side of the base element 11 opposite the opening 13.

The bead 8 is a bead between the cellulose-based sheet 2 forming the circumferential side wall 12 and the cellulose-based bottom region sheet 17 forming the bottom region 16. The bead 8 is implemented so that the bottom region 16 permanently closes off the base element 11 without openings or “leaks”.

In other words, the base element shown in FIG. 4a is a wound cup having a bottom region beaded to the circumferential side wall of the wound cup.

FIG. 4b shows the cellulose-based sheet 2 prior to winding about the base element axis 15.

The cellulose-based sheet 2 includes a side wall region 10 forming the circumferential side wall 12 after winding.

The side wall region 10 can include the starting region 31 described above and the end region 32 described above for fixing the winding in the fixing region 9.

At least the side wall region 10 includes the sealing layer 3 and the barrier layer 4 in the embodiment shown.

The end region 32 and/or the starting region 31 can include a different layer or sequence of layers than the remaining side wall region.

The cellulose-based sheet 2 shown includes a flange region 5 disposed and shaped so that the region forms the circumferential flange 14 after winding.

The cellulose-based sheet 2 shown includes a bead region 6 disposed and shaped so that the region, together with a corresponding bead region 18 of the cellulose-based bottom region sheet 17, can form the bead described above.

FIG. 4c shows the cellulose-based bottom region sheet 17 prior to beading to the cellulose-based sheet 2.

The cellulose-based bottom region sheet 17 includes a region 19 for forming the actual bottom region 16 of the base element 11 after beading.

The cellulose-based bottom region sheet 17 shown further includes the bead region 18. The region is disposed and shaped so that said region, together with the bead region 6 of the cellulose-based sheet 2, can form the bead described above.

In the embodiment shown, at least the region 19 forming the actual bottom region 16 of the base element 11 after beading includes the sealing layer 3 described above and the oxygen barrier layer 4 described above.

FIG. 5a shows a cellulose-based sheet 2 prior to winding about the base element axis 15, as an alternative shape to the cellulose-based sheet 2 shown in FIG. 4b. The cellulose-based sheet 2 shown is configured so that the sheet forms the circumferential side wall 12 and the circumferential flange 14 of a base element 11 having a square basic shape after winding, as shown as an example in FIG. 2.

In comparison to the cellulose-based sheet 2 shown in FIG. 4b, the cellulose-based sheet 2 shown in FIG. 5a includes a side wall region 10 subdivided into four partial regions by intended folds 7. The four partial regions are disposed so that the regions form the four flat sides of the circumferential side wall 12 after winding.

The flange region 5 is further divided into four parts matched to the four partial regions of the side wall region 10. The four parts are disposed and configured so that the parts can run at an angle, not equal to zero, relative to the base element axis 15 and can form the circumferential flange 14 after winding the cellulose-based sheet 2 about the base element axis 15.

The circumferential flange 14 typically runs at about 90° from the base element axis 15, as shown in FIGS. 1, 2, and 4a. That is, the circumferential flange 14 is disposed at least approximately in one plane, the normal thereof running parallel to the base element axis 15.

FIG. 5b shows a cellulose-based bottom region sheet 17, not to scale, matched to the cellulose-based sheet 2 shown in FIG. 5a and able to be attached to the same by means of a bead 8.

The cellulose-based bottom region sheet 17 shown includes a square region 19 for forming the actual bottom region 16 of the base element 11 after beading.

The bead region 18 is further divided into four partial regions, matched to the four partial regions of the side wall region 10. The four partial regions of the bead region 18 are disposed and configured so that the partial regions can be folded away from the square region 19.

The four partial regions of the bead region 18 are disposed and shaped so that the regions, together with the bead region 6 of the cellulose-based sheet 2, can form the bead described above.

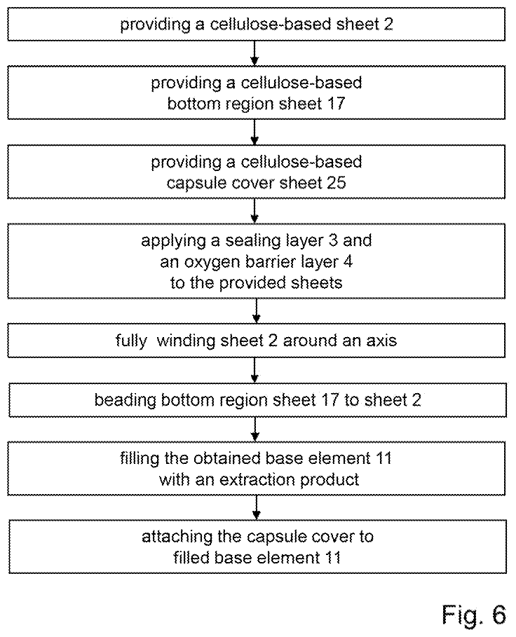

FIG. 6 shows schematically an example method for producing a portion capsule 1 ready for consumption. Optional steps are also shown in the schematic.

The example method shown according to FIG. 6 relates particularly to a portion capsule 1 ready for consumption and including a bottom region 16 beaded to the circumferential side wall 12 and a capsule cover 21 applied by means of ultrasonic welding to a circumferential flange 14 of the circumferential side wall 12.

In a first phase of the method, the elements required for producing a non-filled portion capsule are provided. In particular:
The cellulose-based sheet 2 is provided from which the circumferential side wall 12 and the circumferential flange are ultimately formed.
The cellulose-based bottom region sheet 17 is provided from which the bottom region 16 is ultimately formed.
The cellulose-based capsule cover sheet 25 is provided from which the capsule cover 21 is ultimately formed.
The sealing layer 3 and the oxygen barrier layer 4 are applied to the cellulose-based sheets.

Prior to or after applying the sealing layer 3 and the oxygen barrier layer 4, the cellulose-based sheets can be cut to size, provided with fold regions (if needed), preformed (if needed, such as capsule covers), and/or provided with an additionally processed starting region 31 and/or end region 32 (if needed). In addition or alternatively, one or more attaching areas and/or one or more sealing areas can be prepared.

In a second phase of the method, the base element 11 is formed. To this end, the method includes a step wherein the cellulose-based sheet 2 is deformed so as to form a full winding about an axis. The axis is the base element axis 15 hereafter.

Depending on the shape of the portion capsule to be produced and depending on the cut of the cellulose-based sheet 2 and the cellulose-based bottom region sheet 25, the second phase of the method includes a beading step prior to, during, or after the step of winding. In the beading step, the cellulose-based bottom region sheet 17 is beaded to the cellulose-based sheet 2, so that after the step of winding, the bottom region 16 closes off one end of the circumferential wall 12.

The second phase of the method further typically includes a step wherein the winding is stopped so that the winding is permanent. This step is typically in addition to the step of beading.

In a third phase of the method, the base element 11 available after the second phase is filled with extraction product, for example coffee.

In a fourth phase of the method, the capsule cover 21 is attached to the filled base element 11 in order to seal off the same and to produce the portion capsule 1 ready for consumption.

To this end, the fourth phase includes a step wherein the capsule cover 21, potentially preformed as described in conjunction with FIG. 3, is positioned on the base element 11 so that the cover seals off the opening 13 and that the circumferential flange 14 of the base element 11 makes contact circumferentially with the cover flange 22.

The fourth phase further includes a step wherein the flanges of the base element 11 and of the capsule cover 21 contacting each other are subjected to pressure and ultrasound between an anvil and a sonotrode, so that a weld circumferential to the former opening 13 arises between the flange 14 of the base element 11 and the cover flange 22.

The method can include further phases and steps. For example, a cleaning step, applying inscriptions and/or codes, coloring, etc.

### REFERENCE NUMERALS

1. Portion capsule

2. Cellulose-based sheet (paper)

3. Liquid sealing layer (PLA)

4. Gas transmission barrier layer (SiOₓ)

5. Flange region

6. Bead region

7. Intended fold

Bead

9. Fixing region (of the winding)

10. Side wall region

11. Base element

12. Circumferential side wall

13. Opening

14. Flange of the circumferential side wall

15. Base element axis

16. Bottom region (capsule base)

17. Cellulose-based bottom region sheet

18. Bead region

19. Region forming bottom region 16 after beading

21. Capsule cover

22. Circumferential cover flange

23. Dome

24. Transition region

25. Cellulose-based capsule cover sheet

31. Starting region

32. End region

1. A portion capsule comprising a base element having a bottom region and a circumferential side wall, wherein the bottom region and the circumferential side wall form an interior space, the circumferential side wall comprising a cellulose-based sheet, and wherein the circumferential side wall is formed by a full winding of the cellulose-based sheet about a base element axis.

2. The portion capsule according to claim 1, wherein the base element is cup-like and has a rectangular, particularly square, basic shape.

3. The portion capsule according to claim 1, wherein the cellulose-based sheet comprises a sealing layer or a barrier layer, or a sealing layer and a barrier layer.

4. The portion capsule according to claim 3, wherein the sealing layer or the barrier layer, or the sealing layer and the barrier layer continuously covers an entire region facing toward the interior space.

5. The portion capsule according to claim 1, wherein the bottom region is formed from a cellulose-based bottom region sheet.

6. The portion capsule according to claim 5, wherein the bottom region is beaded to the circumferential side wall.

7. The portion capsule according to claim 1, wherein the bottom region is formed from the cellulose-based sheet.

8. The portion capsule according to claim 7, wherein the bottom region is formed by a folded region of the cellulose-based sheet.

9. The portion capsule according to claim 1, further comprising a capsule cover sealing off the interior space formed by the bottom region and the circumferential side wall, or being configured for sealing off the interior space formed by the bottom region and the circumferential side wall, wherein the capsule cover is formed from a cellulose-based capsule cover sheet.

10. The portion capsule according to claim 1, further comprising a capsule cover sealing off the interior space formed by the bottom region and the circumferential side wall, or being configured for sealing off the interior space formed by the bottom region and the circumferential side wall, wherein the capsule cover is formed from the cellulose-based sheet.

11. The portion capsule according to claim 9, wherein the cellulose-based sheet forming the capsule cover comprises a sealing layer or a barrier layer, or a sealing layer and a barrier layer.

12. The portion capsule according to claim 11, wherein the sealing layer or the barrier layer, or the sealing layer and the barrier layer continuously covers the entire region of the capsule cover facing toward the interior space.

13. A method for producing a portion capsule comprising a base element having a bottom region and a circumferential side wall, the method comprising the following steps:
providing a cellulose-based sheet;
forming the circumferential side wall from the cellulose-based sheet,
and wherein the step of forming the circumferential side wall comprises forming a full winding of the cellulose-based sheet about a base element axis.

14. The method according to claim 13, further comprising at least one of the following steps:
providing a cellulose-based bottom region sheet, forming the bottom region from the cellulose-based bottom region sheet, and beading the bottom region to the circumferential side wall, or processing the cellulose-based sheet so that the cellulose-based sheet comprises a side wall part by means of which the full winding can be formed and a bottom region part from which the bottom region can be formed;
providing a cellulose-based capsule cover sheet and forming the capsule cover from the cellulose-based capsule cover sheet, or processing the cellulose-based sheet so that the cellulose-based sheet comprises a side wall part by means of which the full winding can be formed and a capsule cover part from which the capsule cover can be formed.

15. The method according to claim 14, comprising the step of applying a sealing layer or a barrier layer, or a sealing layer and a barrier layer to at least one of the following sheets: the cellulose-based sheet, the cellulose-based bottom region sheet, the cellulose-based capsule cover sheet.

16. The portion capsule according to claim 10, wherein the cellulose-based sheet forming the capsule cover comprises a sealing layer or a barrier layer, or a sealing layer and a barrier layer.

17. The portion capsule according to claim 16, wherein the sealing layer or the barrier layer, or the sealing layer and the barrier layer continuously covers the entire region of the capsule cover facing toward the interior space.
